(19) United States
(12) Patent Application Publication
(10) Pub. No.: US 2012/0181487 A1
(43) Pub. Date: Jul. 19, 2012

(54) THERMOPLASTIC MOLDING COMPOSITION

(75) Inventors: Cecile Gibon, Mannheim (DE); Xin Yang, Bensheim (DE); Christof Kujat, Neustadt (DE); Martin Weber, Maikammer (DE); Sachin Jain, Jalgaon (IN); Hye Jin Park, Ludwigshafen (DE)

(73) Assignee: BASF SE, Ludwigshafen (DE)

(21) Appl. No.: 13/352,791

(22) Filed: Jan. 18, 2012

Related U.S. Application Data
(60) Provisional application No. 61/433,531, filed on Jan. 18, 2011.

(51) Int. Cl. H01B 1/04; B82Y 40/00; B82Y 30/00

(52) U.S. Cl. 252/511; 977/742; 977/734; 977/842

(57) ABSTRACT

The thermoplastic molding composition comprises, based on the thermoplastic molding composition,
a) as component A, at least one thermoplastic matrix polymer selected from poly-amides, polyesters, polyacetals, and polysulfones, where this can also take the form of polymer blend,
b) as component B, from 0.1 to 5% by weight of at least one highly branched or hyperbranched polymer which has functional groups which can react with the matrix polymer of component A, and
c) as component C, from 0.1 to 15% by weight of conductive carbon fillers selected from carbon nanotubes, graphenes, carbon black, graphite, and mixtures thereof,
   with the exclusion of specific thermoplastic molding compositions.

The invention relates to a thermoplastic molding composition which comprises at least one thermoplastic polymer, at least one highly branched or hyperbranched polymer, and conductive carbon fillers.

The use of carbon fillers in matrix polymers in combination with highly branched or hyperbranched polymers is known per se.

WO 2009/115536 relates to polyamide nanocomposites with hyperbranched polyethyleneimines. The thermoplastic molding compositions described comprise at least one thermoplastic polyamide, at least one hyperbranched polyethyleneimine, at least one amorphous oxide and/or oxide hydrate of at least one metal or semimetal with a number-average diameter of the primary particles of from 0.5 to 20 nm, where the molding compositions can also comprise carbon nanotubes as fillers. Carbon black and graphite can be used concomitantly as pigments.

The hyperbranched polyethyleneimines are used to give reduced melt viscosity together with advantageous mechanical properties.

WO 2008/074687 relates to thermoplastic molding compositions with improved ductility. The molding compositions comprise a semiaromatic polyamide, a copolymer made of ethylene, 1-octene, or 1-butene, or propene, or a mixture of these, and also functional monomers in which the functional group has been selected from carboxylic acid groups, carboxylic anhydride groups, carboxylic ester groups, carboxamide groups, carboximide groups, amino groups, hydroxy groups, epoxy groups, urethane groups, or oxazoline groups, and mixtures of these. The molding compositions can moreover comprise fibrous or particulate fillers, and highly branched or hyperbranched polycarbonates, or highly branched or hyperbranched polyesters. It is also possible to make concomitant use of an electrically conductive additive which by way of example has been selected from carbon nanotubes, graphite, and conductive carbon black. Pigments can also be used concomitantly, an example being carbon black.

The highly branched or hyperbranched polycarbonates or polyesters are used in order to improve flowability and ductility.

EP-A-2 151 415 describes the use, as solubilizer for carbon nanotubes, of specific hyperbranched polymers which have a triarylamine structure, but which do not comprise functional groups that can react with a matrix polymer. The resultant solubilizates can be introduced into polymer resins, inter alia into polyamide resins or polycarbonate resins.

In order to achieve adequate conductivity in thermoplastic matrix polymers, it is usually necessary to add large amounts of fillers that improve conductivity, e.g. carbon nanotubes or conductive carbon black. The result is often severe impairment of the mechanical properties of the thermoplastic polymer matrix. The use of large amounts of these fillers that improve conductivity is moreover very costly.

It is an object of the present invention to provide thermoplastic polymer molding compositions which comprise conductive carbon fillers and which have improved conductivity, or in which the content of carbon fillers can be reduced with retention of conductivity.

The invention achieves the object via a thermoplastic molding composition comprising, based on the thermoplastic molding composition,
a) as component A, at least one thermoplastic matrix polymer selected from polyamides, polyesters, polyacetals, and polysulfones, where this can also take the form of polymer blend,
b) as component B, from 0.1 to 5% by weight of at least one highly branched or hyperbranched polymer which has functional groups which can react with the matrix polymer of component A, and
c) as component C, from 0.1 to 15% by weight of conductive carbon fillers selected from carbon nanotubes, graphenes, carbon black, graphite, and mixtures thereof,
   where the thermoplastic molding composition comprises no amorphous oxides or oxide hydrates of at least one metal or semimetal where the number-average diameter of the primary particles is from 0.5 to 20 nm, with the exclusion of molding compositions which comprise a semiaromatic polyamide and a copolymer made of ethylene, 1-octene, or 1-butene, or propylene, or a mixture of these, and also of functional monomers in which the functional group has been selected from carboxylic acid, carboxylic anhydride groups, carboxylic ester groups, carboxamide groups, carboximide groups, amino groups, hydroxy groups, epoxy groups, urethane groups, and oxazoline groups.

The object is moreover achieved via the use of highly branched or hyperbranched polymers as component B, where these have functional groups which can react with a matrix polymer of a component A, in a thermoplastic molding composition which comprises, as component A, at least one thermoplastic matrix polymer which has been selected from polyamides, polyesters, polyacetals, and polysulfones, and also can take the form of a polymer blend, where the molding composition also comprises, as component C, conductive carbon fillers selected from carbon nanotubes, graphenes, carbon black, graphite, and mixtures thereof, for increasing the conductivity of the thermoplastic molding composition.

It has been found in the invention that the combination of a conductive carbon filler with highly branched or hyperbranched polymers in thermoplastic molding compositions gives significantly increased electrical conductivity. To this end, the highly branched or hyperbranched polymer has functional groups which can react with the matrix polymer. The improved electrical properties permit formulation of materials which have reduced content of conductive fillers.

The proportion of component B in the thermoplastic molding compositions of the invention is from 0.1 to 5% by weight, preferably from 0.2 to 3% by weight, in particular from 0.3 to 1.3% by weight.

The highly branched or hyperbranched polymers of component B have functional groups which can react with the matrix polymer of component A. They can react here under the conditions of shaping of the thermoplastic molding composition, for example when the thermoplastic molding composition is subjected to forming processes, to melting, or to processing in an extruder or kneader or compression mold. It is preferable here that a molecular-weight change, preferably a molecular-weight increase, for example visible through an increase in melt viscosity or in solution viscosity, takes place under the processing conditions, in particular during the extrusion process.

A thermoplastic molding composition with components A, B, and C is preferably reactive. It is considered to be reactive if a significant change in molecular weight or in melt viscosity or in solution viscosity is observed after mixing in particular of components A and B, for example during an extrusion process. A change is considered to be significant if the change of the measured value is greater than the standard deviation of a corresponding measured value.

The highly branched or hyperbranched polymer of component B should therefore be selected appropriately for the matrix polymer of component A, so that reaction of the functional groups is possible.

Hyperbranched compounds are those in which the degree of branching, i.e. the total of the average number of dendritic linkages and terminal units divided by the total of the average number of all linkages (dendritic, linear, and terminal linkages) multiplied by 100 is from 10 to 98%, preferably from 25 to 90%, particularly preferably from 30 to 80%.

For the purposes of the present invention, the “hyperbranched” feature means that the degree of branching (DB) of the relevant polymers, defined as DB (%)=100×(T+Z)/(T+Z+L), where T is the average number of terminally bonded monomer units, Z is the average number of monomer units generating branching, and L is the average number of linearly bonded monomer units in the macromolecules of the respective substances, is from 10 to 98%, preferably from 25 to 90%, and particularly preferably from 30 to 80%.

Hyperbranched polymers, also termed highly branched polymers, differ from dendrimers. Dendrimers are polymers having perfectly symmetrical structure, and can be produced by starting from a central molecule via controlled stepwise linkage of respectively two or more di- or polyfunctional monomers to each previously bonded monomer. Each linkage step therefore multiplies the number of monomer end groups (and therefore of linkages), giving polymers with dendritic structures, ideally spherical, the branches of which respectively comprise exactly the same number of monomer units. By virtue of this perfect structure, the properties of the polymer are in many cases advantageous, examples of those found being low viscosity and high reactivity due to the large number of functional groups at the surface of the sphere. However, a factor complicating the preparation process is that each linkage step requires the introduction and subsequent removal of protective groups, and operations are required to remove contamination. Dendrimers are therefore usually only produced on laboratory scale.

However, highly branched or hyperbranched polymers can be produced by industrial-scale processes. For the purposes of the present invention, the term hyperbranched includes the term highly branched and is used hereinafter to represent both terms. Hyperbranched polymers also have, alongside perfect dendritic structures, linear polymer chains and unequal polymer branches, but this does not significantly impair the properties of the polymer in comparison with those of perfect dendrimers.

The (non-dendrimeric) hyperbranched polymers used in the invention differ from dendrimers by virtue of the degree of branching defined above. In the context of the present invention, the polymers are “dendrimeric” if their degree of branching DB=from 99.9 to 100%. A dendrimer therefore has the maximum possible number of branching points, achievable only through a highly symmetrical structure. For the definition of “degree of branching” see also H. Frey et al., Acta Polym. 1997, 48, 30. For the purposes of this invention, hyperbranched polymers are in essence uncrosslinked macromolecules which have both structural and molecular non-uniformity.

For the purposes of the present invention it is preferable to use high-functionality hyperbranched polyethyleneimines B).

For the purposes of this invention, a high-functionality hyperbranched polyethyleneimine is a product which also has, alongside secondary and tertiary amino groups, where these form the polymer skeleton, an average of at least three, preferably at least six, with particular preference at least ten, terminal or pendant functional groups. The functional groups are preferably primary amino groups. The number of terminal or pendant functional groups is not in principle subject to any upper restriction, but products with a very large number of functional groups can have undesired properties, such as high viscosity or poor solubility. The high-functionality hyperbranched polyethyleneimines of the present invention preferably have no more than 500 terminal or pendant functional groups, in particular no more than 100 terminal or pendant groups.

For the purposes of the present invention, polyethyleneimines are either homo- or copolymers which are obtainable by way of example by the processes in Ullmann's Encyclopedia of Industrial Chemistry, “Aziridines”, electronic release (article published on Dec. 15, 2006), or as in WO-A 94/12560.

The homopolymers are preferably obtainable via polymerization of ethyleneimine (aziridine) in aqueous or organic solution in the presence of Lewis acids or other acids, or of compounds which cleave to give acids. Homopolymers of this type are branched polymers which generally comprise primary, secondary, and tertiary amino groups in a ratio of about 30%:40%:30%. The distribution of the amino groups can be determined by means of ¹³C NMR spectroscopy.

Comonomers used preferably comprise compounds which have at least two amino functions. Suitable comonomers that may be mentioned are by way of example alkylenediamines having from 2 to 10 carbon atoms in the alkylene moiety, preference being given here to ethylenediamine and propylenediamine. Further suitable comonomers are diethylenetriamine, triethylenetetramine, tetraethylenepentamine, dipropylenetriamine, tripropylenetriamine, dihexamethylenetriamine, aminopropylethylenediamine, and bisaminopropylethylenediamine.

The average molar mass (weight average) of polyethyleneimines is usually in the range from 100 to 3 000 000 g/mol, in particular from 800 to 2 000 000 g/mol. The weight-average molar mass here of the polyethyleneimines obtained via catalyzed polymerization of aziridines is usually in the range from 800 to 50 000 g/mol, in particular from 1000 to 30 000 g/mol. Polyethyleneimines of relatively high molecular weight can in particular be obtained via reaction of the polyethyleneimines mentioned with difunctional alkylation compounds, such as chloromethyloxirane or 1,2-dichloro-ethane, or via ultrafiltration of polymers with a broad molecular weight distribution, as described by way of example in EP-A 873371 and EP-A 1177035, or via crosslinking.

Other materials suitable as component B) are crosslinked polyethyleneimines, where these are obtainable via reaction of polyethyleneimines with bi- or polyfunctional crosslinking agents, where these have at least one halohydrin unit, glycidyl unit, aziridine unit, or isocyanate unit, or one halogen atom, as functional group. Examples that may be mentioned are epichlorohydrin, or bischlorohydrin ethers of polyalkylene glycols having from 2 to 100 units of ethylene oxide and/or of propylene oxide, and also the compounds listed in DE-A 19 93 17 20 and U.S. Pat. No. 4,144,123. Processes for producing crosslinked polyethyleneimines are known inter alia from the above-mentioned specifications, and also EP-A 895 521 and EP-A 25 515. The average molar mass of crosslinked polyethyleneimines is usually more than 20 000 g/mol.

Other materials that can be used as component B) are grafted polyethyleneimines, where any compounds capable of reaction with the amino or imino groups of the polyethyleneimines can be used as grafting agents. Suitable grafting agents and processes for producing grafted polyethyleneimines are found by way of example in EP-A 675 914.

Amidated polymers are likewise suitable polyethyleneimines, and are usually obtainable via reaction of polyethyleneimines with carboxylic acids, or their esters or anhydrides, carboxamides, or acyl halides. The amidated polymers can subsequently be crosslinked with the crosslinking agents mentioned to an extent that depends on the content of the amidated nitrogen atoms in the polyethyleneimine chain. It is preferable that up to 30% of the amino functions here are amidated, in order that there is a sufficient number of primary and/or secondary nitrogen atoms still available for a subsequent crosslinking reaction.

Alkoxylated polyethyleneimines are also suitable, and these are obtainable by way of example via reaction of polyethyleneimine with ethylene oxide and/or propylene oxide and/or butylene oxide. Again, alkoxylated polymers of this type can be subsequently crosslinked.

Other polyethyleneimines that are suitable as component B) and that may be mentioned are hydroxylated polyethyleneimines and amphoteric polyethyleneimines (incorporation of anionic groups), and also lipophilic polyethyleneimines, where these are generally obtained via incorporation of long-chain hydrocarbon moieties into the polymer chain. Processes for producing polyethyleneimines of this type are known to the person skilled in the art, and further details in this connection would therefore be superfluous.

A description of suitable polyethyleneimines can be found by referring to WO 2009/115536, and in particular pages 8 to 11 in that document.

Component (B) can be used undiluted or in the form of solution, in particular in the form of aqueous solutions.

The weight-average molar mass of component B), determined by light scattering, is preferably from 800 to 50 000 g/mol, particularly preferably from 1000 to 40 000 g/mol, in particular from 1200 to 30 000 g/mol. The average molar mass (weight average) is preferably determined by means of gel permeation chromatography using pullulan as standard in aqueous solution (water; 0.02 mol/l of formic acid; 0.2 mol/l of KCl).

The glass transition temperature of component B) for the purposes of the present invention is preferably below 50° C., particularly preferably below 30° C., and in particular below 10° C.

An advantageous amine number of component B) to DIN 53176 is in the range from 50 to 1000 mg KOH/g. The amine number of component B) to DIN 53176 is preferably from 100 to 900 mg KOH/g, very preferably from 150 to 800 mg KOH/g.

It is also possible to use highly branched or hyperbranched polyetheramines as component B. Examples of polyetheramines suitable in the invention are described as component B) in WO 2009/077492, see pages 6 to 16 of that document.

The molding compositions of the invention can also comprise, as component B, a highly branched or hyperbranched polycarbonate which has an OH number of from 1 to 600 mg KOH/g of polycarbonate, preferably from 10 to 550 mg KOH/g of polycarbonate, and in particular from 50 to 550 mg KOH/g of polycarbonate (to DIN 53240, Part 2).

The term “hyperbranched polycarbonates” means uncrosslinked macromolecules having hydroxy groups and having carbonate groups, where these have both structural and molecular non-uniformity. They can be constructed by starting from a central molecule by analogy with dendrimers, but with non-uniform chain length of the esters. They can also have a linear structure, having functional pendant groups, or, combining the two extremes, can have linear and branched portions of the molecule.

Highly branched or hyperbranched polycarbonates or polyesters suitable in the invention are described by way of example in WO 2008/074687, see pages 9 to 19 in that document for the polycarbonates, and pages 19 to 29 for hyperbranched polyesters.

Hyperbranched polyesters differ from the polycarbonates in comprising carboxy groups, alongside hydroxy groups.

The invention excludes the thermoplastic molding compositions which are described in WO 2008/074687 and WO 2009/115536 and which comprise conductive carbon fillers.

The thermoplastic molding compositions of the invention comprise, as component A, at least one thermoplastic matrix polymer selected from polyamides, polyesters, polyacetals, and polysulfones, where these can also take the form of polymer blend.

The invention can preferably use, as component A, at least one polyamide, copolyamide, or polymer blend comprising polyamide.

The polyamides used in the invention are produced via reaction of starting monomers selected by way of example from dicarboxylic acids and diamines, or from salts made of the dicarboxylic acids and diamines, or from aminocarboxylic acids, aminonitriles, lactams, and mixtures thereof. Starting monomers for any desired polyamides can be involved here, examples being those for aliphatic, semiaromatic, or aromatic polyamides. The polyamides can be amorphous, crystalline, or semicrystalline. The polyamides can moreover have any desired viscosities and/or molecular weights. Particularly suitable polyamides have aliphatic, semicrystalline, or semiaromatic, or else amorphous structure of any type.

The intrinsic viscosity of these polyamides is generally from 90 to 350 ml/g, preferably from 110 to 240 ml/g, determined in a 0.5% strength by weight solution in 96% strength by weight sulfuric acid at 25° C. to ISO 307.

Semicrystalline or amorphous resins with molecular weight (weight average) at least 5000 are preferred, these being described by way of example in U.S. Pat. Nos. 2,071,250, 2,071,251, 2,130,523, 2,130,948, 2,241,322, 2,312,966, 2,512,606, and 3,393,210. Examples of these are polyamides which derive from lactams having from 7 to 11 ring members, e.g. polycaprolactam and polycaprylolactam, and also polyamides which are obtained via reaction of dicarboxylic acids with diamines.

Dicarboxylic acids that can be used are alkanedicarboxylic acids having from 6 to 12, in particular from 6 to 10, carbon atoms, and aromatic dicarboxylic acids. Mention may be made here of the following acids: adipic acid, azelaic acid, sebacic acid, dodecanedioic acid (=decanedicarboxylic acid), and terephthalic and/or isophthalic acid.

Particularly suitable diamines are alkanediamines having from 2 to 12, in particular from 6 to 8, carbon atoms, and also m-xylylenediamine, di(4-aminophenyl)methane, di(4-aminocyclohexyl)methane, 2,2-di(aminophenyl)propane, or 2,2-di(4-aminocyclo-hexyl)propane, and also p-phenylenediamine.

Preferred polyamides are polyhexamethyleneadipamide (PA 66) and polyhexamethylenesebacamide (PA 610), polycaprolactam (PA 6), and also nylon-6/6,6 copolyamides, in particular having from 5 to 95% by weight content of caprolactam units. Particular preference is given to PA 6, PA 66, and nylon-6/6,6 copolyamides.

Mention may also be made of polyamides which are obtainable by way of example via condensation of 1,4-diaminobutane with adipic acid at elevated temperature (nylon-4,6). Production processes for polyamides having this structure are described by way of example in EP-A 38 094, EP-A 38 582, and EP-A 39 524.

Other examples are polyamides which are obtainable via copolymerization of two or more of the abovementioned monomers, or a mixture of two or more polyamides, in any desired mixing ratio.

Semiaromatic copolyamides, such as PA 6/6T and PA 66/6T, have moreover proven to be particularly advantageous, where the triamine content of these is less than 0.5% by weight, preferably less than 0.3% by weight (see EP-A 299 444). The low-triamine-content semiaromatic copolyamides can be produced by the processes described in EP-A 129 195 and 129 196. For semiaromatic polyamides, reference can moreover be made to WO 2008/074687.

The following non-exhaustive list comprises the polyamides mentioned, and also other polyamides for the purposes of the invention (the monomers being stated between parentheses):

PA 26 (ethylenediamine, adipic acid)
PA 210 (ethylenediamine, sebacic acid)
PA 46 (tetramethylenediamine, adipic acid)
PA 66 (hexamethylenediamine, adipic acid)
PA 69 (hexamethylenediamine, azelaic acid)
PA 610 (hexamethylenediamine, sebacic acid)
PA 612 (hexamethylenediamine, decanedicarboxylic acid)
PA 613 (hexamethylenediamine, undecanedicarboxylic acid)
PA 1212 (1,12-dodecanediamine, decanedicarboxylic acid)
PA 1313 (1,13-diaminotridecane, undecanedicarboxylic acid)
PA MXD6 (m-xylylenediamine, adipic acid)
PA TMDT (trimethylhexamethylenediamine, terephthalic acid)
PA 4 (pyrrolidone)
PA 6 (ε-caprolactam)
PA 7 (ε-amino-enanthicaciol)
PA 8 (capryllactam)
PA 9 (9-aminononanoic acid)
PA11 (11-aminoundecanoic acid)
PA12 (laurolactam)
polyphenylenediamineterephthalamide (phenylenediamine, terephthalic acid).

These polyamides and production thereof are known. Details concerning their production are found by the person skilled in the art in Ullmanns Enzyklopadie der Technischen Chemie [Ullmann's Encyclopedia of Industrial Chemistry], 4th edition, vol. 19, pp. 39-54, Verlag Chemie, Weinmann 1980, and also Ullmann's Encyclopedia of Industrial Chemistry, vol. A21, pp. 179-206, VCH Verlag, Weinheim 1992, and also Stoeckhert, Kunststofflexikon [Plastics Encyclopedia], PP. 425-428, Hanser Verlag, Munich 1992 (keyword “Polyamide” [Polyamides] ff.).

It is particularly preferable to use nylon-6, nylon-66, or nylon-MXD,6 (adipic acid/m-xylylenediamine).

It is moreover possible in the invention to provide functionalizing compounds in the polyamides, where these are capable of linkage to carboxy or amino groups and by way of example have at least one carboxy, hydroxy, or amino group. Compounds involved here are preferably

monomers which have branching effect, where these by way of example have at least three carboxy or amino groups,
monomers capable of linkage to carboxy or amino groups, e.g. via epoxy, hydroxy, isocyanato, amino, and/or carboxy groups, and which have functional groups selected from hydroxy groups, ether groups, ester groups, amide groups, imine groups, imide groups, halogen groups, cyano groups, and nitro groups, C—C double bonds, or C—C triple bonds,
or polymer blocks capable of linkage to carboxy or amino groups, for example poly-p-aramide oligomers.

Use of the functionalizing compounds can adjust the property profile of the resultant polyamides within a wide range.

By way of example, triacetonediamine compounds can be used as functionalizing monomers. These preferably involve 4-amino-2,2,6,6-tetramethylpiperidine or 4-amino-1-alkyl-2,2,6,6-tetramethylpiperidine, where the alkyl group in these has from 1 to 18 carbon atoms or has been replaced by a benzyl group. The amount present of the triacetonediamine compound is preferably from 0.03 to 0.8 mol %, particularly preferably from 0.06 to 0.4 mol %, based in each case on 1 mole of amide group of the polyamide. Reference can be made to DE-A-44 13 177 for further details.

It is also possible to use, as further functionalizing monomers, the compounds usually used as regulators, examples being monocarboxylic acids and dicarboxylic acids. Reference can likewise be made to DE-A-44 13 177 for details.

Component A can also comprise at least one further blend polymer, alongside one or more polyamides or copolyamides. The proportion in the blend polymer here of component A is preferably from 0 to 60% by weight, particularly preferably from 0 to 50% by weight, in particular from 0 to 40% by weight. If the blend polymer is present, the minimum amount thereof is preferably 5% by weight, particularly preferably at least 10% by weight.

Blend polymers that can be used are by way of example natural or synthetic rubbers, acrylate rubbers, polyesters, polyolefins, polyurethanes and mixtures thereof, optionally in combination with a compatibilizer.

Synthetic rubbers that may be mentioned as useful are ethylene-propylene-diene rubber (EPDM), styrene-butadiene rubber (SBR), butadiene rubber (BR), nitrile rubber (NBR), hydrin rubber (ECO), and acrylate rubbers (ASA). Silicone rubbers, polyoxyalkylene rubbers, and other rubbers are also useful.

Thermoplastic elastomers that may be mentioned are thermoplastic polyurethane (TPU), styrene-butadiene-styrene block copolymers (SBS), styrene-isoprene-styrene block copolymers (SIS), styrene-ethylene-butylene-styrene block copolymers (SEBS), and styrene-ethylene-propylene-styrene block copolymers (SEPS).

It is also possible to use resins in the form of blend polymers, examples being urethane resins, acrylic resins, fluoro resins, silicone resins, imide resins, amidimide resins, epoxy resins, urea resins, alkyd resins, and melamine resin.

It is also possible to use ethylene copolymers in the form of blend polymer, for example copolymers made of ethylene and 1-octene, 1-butene, or propylene, as described in WO 2008/074687. The molar masses of these ethylene-α-olefin copolymers are preferably in the range from 10 000 to 500 000 g/mol, with preference from 15 000 to 400 000 g/mol (number-average molar mass). It is also possible to use homopolyolefins, such as polyethylene or polypropylene.

Reference can be made to EP-B-1 984 438, DE-A-10 2006 045 869 and EP-A-2 223 904 for suitable polyurethanes.

Paragraph [0028] of JP-A-2009-155436 lists other suitable thermoplastic resins.

As an alternative, it is also possible to use polyesters, polyacetals, and polysulfones as component A.

In polyesters, any desired suitable dicarboxylic acid can have been reacted with any desired suitable diols. Examples of dicarboxylic acids that can be reacted are oxalic acid, malonic acid, succinic acid, glutaric acid, adipic acid, pimelic acid, suberic acid, azelaic acid, sebacic acid, undecane-alpha,omega-dicarboxylic acid, dodecane-alpha,omega-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and also cis- and trans-cyclopentane-1,3-dicarboxylic acid. These dicarboxylic acids can also be used in substituted form. By way of example, it is possible to use 2-methylmalonic acid, 2-ethylmalonic acid, 2-phenylmalonic acid, 2-methylsuccinic acid, 2-ethylsuccinic acid, 2-phenylsuccinic acid, itaconic acid, or 3,3-dimethylglutaric acid.

Other useful compounds are ethylenically unsaturated acids, such as maleic acid or fumaric acid, and also aromatic dicarboxylic acids, such as phthalic acid, isophthalic acid, or terephthalic acid.

It is particularly preferable to use succinic acid, glutaric acid, adipic acid, phthalic acid, isophthalic acid, terephthalic acid, or monomethyl or dimethyl esters thereof.

Examples of diols used are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, or a mixture of two or more of the above compounds, where n is an integer and n=from 4 to 25. It is also possible here to replace one, or else both, hydroxy groups in the abovementioned diols by SH groups. Preference is given to ethylene glycol, propane-1,2-diol, and also diethylene glycol, triethylene glycol, dipropylene glycol, and tripropylene glycol.

The weight-average molar mass of the polyesters is preferably from 500 to 50 000 g/mol.

Particular polyacetals useful in the invention are polyoxymethylene homopolymers and polyoxymethylene copolymers. Other polyacetals are also useful in the invention.

Polysulfones used in the invention are preferably aromatic polysulfones.

For blend polymers, reference can be made to the blend polymers described above in relation to the polyamides. The proportions by weight stated there are also applicable to the blend polymers.

In one embodiment of the invention, component A is a polyamide and component B is a highly branched or hyperbranched polyethyleneimine or a highly branched or hyperbranched polyetheramine.

In another embodiment of the invention, component A is a polyester and component B is a highly branched or hyperbranched polycarbonate or a highly branched or hyperbranched polyester.

The thermoplastic molding compositions comprise, as component C, from 0.1 to 15% by weight of conductive carbon fillers selected from carbon nanotubes, graphenes, carbon black (in particular conductive carbon black), graphite, and mixtures thereof. The thermoplastic molding composition preferably comprises an amount of from 0.1 to 7% by weight, based on the thermoplastic molding composition, of carbon nanotubes, graphenes, or a mixture thereof. The amount used of carbon black, graphite, or a mixture thereof is preferably 3 to 15% by weight, based on the thermoplastic molding composition.

Suitable carbon nanotubes and graphenes are known to the person skilled in the art. For a description of suitable carbon nanotubes (CNT), reference may be made to DE-A-102 43 592, in particular paragraphs [0025] to [0027], also to EP-A-2 049 597, in particular page 16, lines 11 to 41, or DE-A-102 59 498, paragraphs [0131] to [0135]. Suitable carbon nanotubes are moreover described in WO 2006/026691, paragraphs [0069] to [0074]. Suitable carbon nanotubes are moreover described in WO 2009/000408, page 2, line 28 to page 3, line 11.

For the purposes of the present invention, the term “carbon nanotubes” means carbon-containing macromolecules in which the carbon (predominantly) has graphite structure and the individual graphite layers have been arranged in the form of a tube. Nanotubes, and also the synthesis thereof, are known in the literature (an example being J. Hu et al., Acc. Chem. Res. 32 (1999), 435-445). In principle, any type of nanotube can be used for the purposes of the present invention.

It is preferable that the diameter of the individual tubular graphite layers (graphite tubes) is from 4 to 20 nm, in particular from 5 to 10 nm. Nanotubes can in principle be divided into what are known as single-walled nanotubes (SWNTs) and multiwalled nanotubes (MWNTs). In the MWNTs, there are therefore a plurality of overlapping graphite tubes.

The exterior shape of the tubes can moreover vary and can have uniform internal and external diameter, but it is also possible to produce tubes in the shape of a knot and to produce vermicular structures.

The aspect ratio (length of respective graphite tube in relation to its diameter) is at least >10, preferably >5. The length of the nanotubes is at least 10 nm. For the purposes of the present invention, MWNTs are preferred as component B). In particular, the aspect ratio of the MWNTs is about 1000:1 and their average length is in particular about 10 000 nm.

BET specific surface area is generally from 50 to 2000 m²/g, preferably from 200 to 1200 m²/g. The impurities (e.g. metal oxides) arising during the catalytic production process generally amount to from 0.1 to 12%, preferably from 0.2 to 10%, as measured by HRTEM.

Suitable “multiwall” nanotubes can be purchased from Hyperion Catalysis Int., Cambridge, Mass. (USA) (see also EP 205 556, EP 969 128, EP 270 666, U.S. Pat. No. 6,844,061).

Suitable graphenes are described by way of example in Macromolecules 2010, 43, pages 6515 to 6530.

Suitable carbon blacks and graphites are known to the person skilled in the art.

The carbon black is in particular a conductive carbon black. Any familiar form of carbon black can be used as conductive carbon black, and by way of example the commercially available product Ketjenblack 300 from Akzo is suitable.

Conductive carbon black can also be used for conductivity modification. Carbon black conducts electrons by virtue of graphite-type layers embedded within amorphous carbon (F. Camona, Ann. Chim. Fr. 13, 395 (1988)). The current is conducted within the aggregrates made of carbon black particles and between the aggregates, if the distances between the aggregates are sufficiently small. in order to achieve conductivity while minimizing the amount added, it is preferable to use carbon blacks having anisotropic structure (G. Wehner, Advances in Plastics Technology, APT 2005, Paper 11, Katowice 2005). In these carbon blacks, the primary particles form aggregates giving anisotropic structures, and the necessary distances between the carbon black particles for achieving conductivity in compounded materials are therefore achieved even at comparatively low loading (C. Van Bellingen, N. Probst, E. Grivei, Advances in Plastics Technology, APT 2005, Paper 13, Katowice 2005).

The oil absorption of suitable types of carbon black (measured to ASTM D2414-01) is by way of example 60 ml/100 g, preferably more than 90 ml/100 g. BET surface area of suitable products is more than 50 m²/g, preferably more than 60 m²/g (measured to ASTM D3037-89). There can be various functional groups on the surface of carbon black. Various processes can be used to produce the carbon blacks (G. Wehner, Advances in Plastics Technology, APT 2005, Paper 11, Katowice 2005).

It is also possible to use graphite as conductivity additive. The term “graphite” means a form of carbon as described by way of example in A. F. Holleman, E. Wiberg, “Lehrbuch der anorganischen Chemie” [Textbook of inorganic chemistry], 91st-100th edn., pp. 701-702. Graphite is composed of planar carbon layers mutually superposed. Graphite can be comminuted by grinding. Particle size is in the range from 0.01 μm to 1 mm, preferably in the range from 1 to 250 μm.

Carbon black and graphite are described by way of example in Donnet, J. B. et al., Carbon Black Science and Technology, second edition, Marcel Dekker, Inc., New York 1993. It is also possible to use conductive carbon black, which is based on carbon black having a highly ordered structure. This is described by way of example in DE-A-102 43 592, in particular [0028] to [0030], in EP-A-2 049 597, in particular page 17, lines 1 to 23, in DE-A-102 59 498, in particular in paragraphs [0136] to [0140], and also in EP-A-1 999 201, in particular page 3, lines 10 to 17.

The thermoplastic molding compositions of the invention can moreover comprise further additional materials, for example further fillers, e.g. glass fibers, stabilizers, oxidation retarders, agents to counteract decomposition by heat and decomposition by ultraviolet light, lubricants and mold-release agents, colorants, such as dyes and pigments, nucleating agents, plasticizers, etc. Amounts typically present of these further additional materials are from 0 to 50% by weight, preferably from 0 to 35% by weight. Reference may be made to WO 2008/074687, pages 31 to 37 for a more detailed description of possible additional materials.

The invention also provides a process for producing the thermoplastic molding compositions described above, via mixing of the components, preferably in an extruder.

The thermoplastic molding compositions of the invention are produced by way of example via extrusion processes, at temperatures conventional for thermoplastics processing.

By way of example, it is possible to use a process as described in DE-A-10 2007 029 008. Reference may also be made to WO 2009/000408 for the production process.

Production preferably takes place in a corotating twin-screw extruder, by introducing components B and C into component A.

Component C can be introduced in the form of powder or in the form of a masterbatch into a thermoplastic molding composition. Component B can be introduced independently of the introduction of the conductive filler of component C, for example by using “hot feed” to the extruder. As an alternative, a masterbatch comprising component B can be used. It is also possible to add components B and C in mixed form.

The thermoplastic molding composition can be further processed by known methods, for example via injection molding or compression molding.

The process of the invention permits production of thermoplastic molding compositions filled with the carbon fillers of component C with low-energy cost and good levels of dispersion.

The production process of the invention renders the thermoplastic molding compositions, or moldings produced therefrom, antistatic or conductive. The term “antistatic” means volume resistivities of from 10⁹ to 10⁶ ohm cm. The term “conductive” means volume resistivities below 10⁶ ohm cm.

The thermoplastic molding compositions of the invention are in particular used for producing conductive moldings.

The invention also provides moldings made of the thermoplastic molding composition described above.

The examples below provide further explanation of the invention.

### EXAMPLES

The following starting materials were used for producing the thermoplastic molding composition:

### Thermoplastic Matrix:

A1: Nylon-6 with intrinsic viscosity (IV) 150 ml/g
A2: Nylon-6 with intrinsic viscosity (IV) 170 ml/g
A3: Polybutylene terephthalate (PBT) with intrinsic viscosity (IV) 130 ml/g
A4: unmodified LDPE with density (ISO 1183) 0.923 g/cm³, Shore D hardness (ISO 868) 48, and melt flow rate (MFR; ISO 1133) 0.75 g/10 min (190° C., 2.16 kg) (Lupolen® A 2420 F)

### Conductive Fillers:

C1: Printex XE2B conductive carbon black from Evonik
C2: Graphene masterbatch (9%) produced using Vorbeck graphite
C3: Carbon nanotubes in the form of a 15% by weight masterbatch in nylon-6 made from Nanocyl NC 7000
C4: Carbon nanotubes in the form of a 15% by weight masterbatch in polybutylene terephthalate from Nanocyl NC 7000

### Hyperbranched Polymers:

B1: Polyethyleneimine having weight-average molecular weight 25 000, pH 11, viscosity 350 Pa s at 20° C., and primary/secondary/tertiary amine ratio 1/1.20/0.76 (Lupasol® WF from BASF SE)
B2: Polyethyleneimine having weight-average molar mass 1300 g/mol, pH 11, viscosity 20 000 Pa s at 20° C., and primary/secondary/tertiary amine ratio 1/0.91/0.64 (Lupasol® G20 from BASF SE)
B3: Hyperbranched polycarbonate produced as follows:

The polyhydric alcohol, diethyl carbonate, and 0.15% by weight of potassium carbonate as catalyst (amount based on amount of alcohol) were used as initial charge in accordance with the batch quantities of Table 1 in a three-necked flask equipped with stirrer, reflux condenser, and internal thermometer, and the mixture was heated to 140° C. and stirred at this temperature for 2 h. The temperature of the reaction mixture here decreased with increasing reaction time because of onset of evaporative cooling due to the ethanol liberated. The reflux condenser was then replaced by an inclined condenser and one equivalent of phosphoric acid, based on the equivalent amount of catalyst, was added, ethanol was removed by distillation, and the temperature of the reaction mixture was slowly increased to 160° C. The alcohol removed by distillation was collected in a cooled round-bottomed flask and weighed, and conversion was thus determined as a percentage of the full conversion theoretically possible (see Table 0).

Dry nitrogen was then passed through the reaction mixture at 160° C. for a period of 1 h in order to remove remaining residual amounts of monomers. The reaction mixture was then cooled to room temperature.

Analysis of polycarbonates of the invention: The polycarbonates were analyzed by gel permeation chromatography, using a refractometer as detector. Dimethylacetamide was used as mobile phase, and polymethyl methacrylate (PMMA) was used as standard for molecular weight determination.

OH number was determined to DIN 53240, Part 2.

TABLE 0
Starting materials and final products

| | | | Distillate, | | |
|---|---|---|---|---|---|
| | | | amount of | | OH number |
| | | | alcohol, | Molar mass | of product |
| | | | based on | of product | (mg KOH/g) |
| | | Molar ratio | complete | (g/mol) | to |
| Ex. | | of alcohol | conversion, | Mw | DIN 53240, |
| No. | Alcohol | to carbonate | mol % | Mn | Part 2 |
| 1 | TmP × | 1:1 | 72 | 2300 | 400 |
| | 1.2 PO | | | 1500 | |

TMP = trimethylolpropane
PO = propylene oxide

The expression “TMP×1.2 PO” in the table describes a product which has been reacted with an average of 1.2 mol of propylene oxide per mole of trimethylolpropane.

### Characterization Methods:

Intrinsic viscosity IV of the polyamide was determined to ISO 307 in 0.5% strength by weight solution in 96% strength by weight sulfuric acid at 25° C.

MFR of polyethylene was determined to ISO 1133 at 190° C. under a load of 2.16 kg.

### Size Exclusion Chromatography (SEC):

Size exclusion chromatography used an Agilent 1100 (concentration detector (DRI), devolatilizer, UV, and pump) with a light-scattering detector (Dawn EUS). Hexafluoroisopropanol (HFIP) was used as solvent with 0.05% by weight of potassium trifluoroacetate at 1.0 mL/min. The columns (precolumn PL HFIPgel and HTS PL HFIPgel from Polymer Laboratories, 4.6 mm) were thermostated to 40° C. in a column oven. In each pass, 25 μL were injected, using a concentration of about 1.5 mg/mL. All of the specimens were filtered prior to injection (Millipore Millex FG, pore diameter 0.2 μm).

Electrical conductivity was measured in the form of volume conductivity, using a 4-point measurement system. For each sheet, the measurement was made on five specimens of dimensions 77×12×4 mm³ which had been sawn from hardened sheets. In order to achieve good contact between specimen and electrodes, four silver electrodes were directly painted onto the specimen by using a conductive silver paste (conductive silver paste 200 from Hans Wohlbring GmbH). The current source used was current source 225, the voltage measurement equipment used was Programmable Electrometer 617, and the current measurement equipment used was Multimeter 1000, in each case from Keithley Instruments.

### Method 1:

The molding compositions were produced by diluting the masterbatches with nylon-6 and introducing these and the other materials into a DSM 15 extruder for the compounding process. The extrusion process used a melt temperature of 270° C., a rotation rate of 80 rpm, and a residence time of 5 minutes. The specimens were then injection-molded in the form of sheets with dimensions 30×30×1.27 mm³ for conductivity measurement. The injection-molded sheets were produced in a 12 mL Xplor molding machine using a melt temperature of 270° C., a mold temperature of 80° C., an injection pressure of from 12 to 16 bar, and a cycle time of 15 seconds. Table 1 below collates the constitution of the molding compositions and the volume resistivity determined.

Compression-molded specimens (30×31×1.6 mm³) were produced by collecting the extrudate and melting it for 4 minutes at 270° C. under from 20 to 30 bar, and compressing it under 200 bar for 2 minutes at 270° C. The specimens were then cooled to room temperature under 200 bar.

### Method 2:

### Use of a Corotating Twin-Screw Extruder for Processing

The carbon-filled molding compositions were produced by using a ZSK extruder from Coperion with screw diameter 18 mm. The extruder had 11 zones, and the polymer was charged cold here in zones 0 and 1. Zones 2 and 3 served for melting and transportation. In zone 4, the hyperbranched polymer was metered into the extruder by way of a hotfeed system. The next zones, 5 and 6, served for dispersion, and a portion of zone 6 here also served together with zone 7 for homogenization. In zones 8 and 9, a redispersion process was carried out. Zone 10 was then used for devolatilization, and zone 11 for discharge.

A gear pump was used to introduce the hyperbranched polymer into zone 4. Extruder throughput was adjusted to 5 kg/h, and screw speed was kept constant at 400 rpm. Extrusion temperature was 260° C. The products were pelletized and further processed by injection molding. The injection molding process used an Arburg 420 C with melt temperature 260° C. and mold temperature 80° C.

Reactivity of Component B with Component A

To determine the reactivity of component B with component A, molecular weight was determined after 2 minutes, after 6 minutes and after 17 minutes. The production process used method 1. The residence time in the extruder was varied here. Table 1 below collates the results:

TABLE 1

| | | | | | Mw | Mw | Mw |
|---|---|---|---|---|---|---|---|
| | A | | B | | at 2 min | at 6 min | at 17 min |
| Specimen | A1 | A2 | B1 | B2 | Da | Da | Da |
| Ref. 1 | 100 | | | | 31 500 | 31 600 | 31 900 |
| Ref. 2 | | 100 | | | 36 000 | 36 500 | 36 700 |
| Ex. 1 | 99 | | 1 | | 29 800 | 40 900 | 47 400 |
| Ex. 2 | 99 | | | 1 | 28 500 | 32 600 | 38 400 |
| Ex. 3 | | 99 | 1 | | 34 900 | 44 900 | 63 700 |
| Ex. 4 | | 99 | | 1 | 33 200 | 34 800 | 34 800 |

Whereas there was hardly any change in the molecular weights for the unmodified polyamides, a continuous increase in molecular weight was observed for the mixtures of Examples 1 to 4. This shows that component B can react with component A. Molecular weight initially decreased when component B was added, but during a period of less than 3 minutes it in turn increased.

### Effect of Various Fillers

Various conductive fillers C1, C2, and C3 were used with starting components A1 and B1. The production process used method 1. The respective comparisons used molding compositions comprising, or not comprising, component B. Volume conductivity was in each case better for the molding compositions which comprised component B. Table 2 below collates the results:

TABLE 2

| | A % | | C | | | | B | | Volume resistivity |
|---|---|---|---|---|---|---|---|---|---|
| Specimen | by wt. | | % by wt. | | | | % by wt. | | (ohm cm) |
| Ref. 3 | A1 | 95 | C1 | 5 | | | | | 5.5E+11 |
| Ex. 5 | A1 | 94 | C1 | 5 | | | B1 | 1 | 2.7E+04 |
| Ref. 4 | A1 | 95 | C2 | | 5 | | | | 3.7E+04 |
| Ex. 6 | A1 | 94 | C2 | | 5 | | B1 | 1 | 8.7E+03 |
| Ref. 5 | A1 | 97 | C3 | | | 3 | | | 2.2E+08 |
| Ex. 7 | A1 | 96 | C3 | | | 3 | B1 | 1 | 2.8E+03 |

### Volume Resistivity of Moldings Produced Via Compression Molding and Injection (by Method 2)

Volume resistivities are collated in Table 3 below.

TABLE 3

| | | | | | | | Volume resistivity | |
|---|---|---|---|---|---|---|---|---|
| | A | | C | | B | | (ohm cm) | |
| Specimen | % by wt. | | % by wt. | | % by wt. | | Injection | Compression |
| Ref. 6 | A1 | 97 | C3 | 3 | | | 1.73E+02 | 9.2E+00 |
| Ex. 8 | A1 | 94 | C3 | 3 | B1 | 3 | 1.21E+03 | 1.1E+01 |
| Ex. 9 | A1 | 94 | C3 | 3 | B2 | 3 | 9.27E+02 | 9.3E+00 |
| Ex. 10 | A1 | 96 | C3 | 3 | B1 | 1 | 2.26E+03 | 1.0E+01 |
| Ex. 11 | A1 | 96 | C3 | 3 | B2 | 1 | 7.95E+10 | 7.03E+03 |

The volume resistivities for the moldings obtained via compression were markedly smaller than for the molding's produced via injection. Without adopting any particular theory, it is possible that longitudinal orientation of the fillers takes place in the moldings produced via injection, resulting in less network formation.

Volume resistivity for polyamide products and addition of carbon fillers

In the molding compositions and comparative molding compositions of which the volume resistivity has been collated in Table 4 below, a comparison is made between molding compositions which comprised carbon fillers and molding compositions which comprised no carbon fillers, but nevertheless comprised hyperbranched polymers. They were produced by method 2. Table 4 collates the results:

TABLE 4

| | A | | C % | | B % | | A4 % | | Volume resistivity |
|---|---|---|---|---|---|---|---|---|---|
| Specimen | % by wt. | | by wt. | | by wt. | | by wt. | | (ohm cm) |
| Ref. 7 | A1 | 97 | C3 | 3 | | | | | 2.7E+12 |
| Ref. 8 | A1 | 98 | C3 | 2 | | | | | 1.5E+12 |
| Ref. 9 | A1 | 99 | C3 | 1 | | | | | 1.2E+12 |
| Ex. 12 | A1 | 96.5 | C3 | 3 | B1 | 0.5 | | | 3.7E+04 |
| Ex. 13 | A1 | 97.5 | C3 | 2 | B1 | 0.5 | | | 2.5E+11 |
| Ex. 14 | A1 | 98.5 | C3 | 1 | B1 | 0.5 | | | 1.1E+12 |
| Ex. 15 | A1 | 96.5 | C3 | 3 | B2 | 0.5 | | | 1.0E+05 |
| Ex. 16 | A1 | 97.5 | C3 | 2 | B2 | 0.5 | | | 1.1E+05 |
| Ex. 17 | A1 | 98.5 | C3 | 1 | B2 | 0.5 | | | 7.4E+08 |
| Ex. 18 | A1 | 77 | C3 | 3 | | | A4 | 30 | 1.9E+07 |
| Ex. 19 | A1 | 76 | C3 | 3 | B1 | 1 | A4 | 30 | 8.8E+02 |

When the molding compositions comprising carbon fillers are compared with the molding compositions which comprise only the hyperbranched polymers, the former exhibit considerably reduced volume resistivity.

### Volume Resistivity for Specimens Comprising PBT

Table 5 below collates the volume resistivities for specimens comprising PBT. They were produced by method 2. A comparison is made here between specimens which comprise hyperbranched polymers and specimens which comprise no hyperbranched polymers. Table 5 collates the results:

TABLE 5

| | A | | C | | B | | Volume resistivity |
|---|---|---|---|---|---|---|---|
| Specimen | % by wt. | | % by wt. | | % by wt. | | (ohm cm) |
| Ref. 10 | A3 | 98 | C4 | 2 | | | 6.0E+03 |
| Ex. 20 | A3 | 97 | C4 | 2 | B3 | 1 | 1.7E+03 |
| Ref. 11 | A3 | 99 | C4 | 1 | | | 6.4E+11 |
| Ex. 21 | A3 | 98 | C4 | 1 | B3 | 1 | 1.5E+06 |

From the results it is clear that the molding compositions of the invention always exhibit markedly lower volume resistivities.

1-9. (canceled)

10. A thermoplastic molding composition comprising, based on the thermoplastic molding composition,
a) as component A, at least one thermoplastic matrix polymer wherein the polymer is a polyamide or a polyester, where this can also take the form of polymer blend,
b) as component B, from 0.1 to 5% by weight of at least one highly branched or hyperbranched polymer which has functional groups which can react with the matrix polymer of component A, and
c) as component C, from 0.1 to 15% by weight of conductive carbon fillers selected from carbon nanotubes, graphenes, carbon black, graphite, and mixtures thereof,
wherein the thermoplastic molding composition comprises no amorphous oxides or oxide hydrates of at least one metal or semimetal where the number-average diameter of the primary particles is from 0.5 to 20 nm, with the exclusion of molding compositions which comprise a semiaromatic polyamide and a copolymer made of ethylene, 1-octene, or 1-butene, or propylene, or a mixture of these, and also of functional monomers in which the functional group has been selected from carboxylic acid, carboxylic anhydride groups, carboxylic ester groups, carboxamide groups, carboximide groups, amino groups, hydroxy groups, epoxy groups, urethane groups, and oxazoline groups, wherein component A is a polyamide and component B is a highly branched or hyperbranched polyethyleneimine or component A is a polyester and component B is a highly branched or hyperbranched polycarbonate or a highly branched or hyperbranched polyester.

11. The thermoplastic molding composition according to claim 10, wherein an amount of from 3 to 15% by weight, based on the thermoplastic molding composition, of carbon black, graphite, or a mixture thereof is used as component C.

12. The thermoplastic molding composition according to claim 10, wherein the amount of component B used is from 0.2 to 3% by weight, based on the thermoplastic molding composition.

13. The thermoplastic molding composition according to claim 11, wherein the amount of component B used is from 0.2 to 3% by weight, based on the thermoplastic molding composition.

14. The thermoplastic molding composition according to claim 10, wherein component A comprises, as blend polymer, natural or synthetic rubbers, acrylate rubbers, polyesters, polyolefins, polyurethanes, or a mixture thereof, optionally in combination with a compatibilizer.

15. The thermoplastic molding composition according to claim 10, wherein component B reacts with component A under thermoplastics-processing conditions, with a change of molecular weight.

16. The thermoplastic molding composition according to claim 10, wherein the polyamides in component A have been selected from the list below, where the starting monomers have been stated between parentheses:
PA 26 (ethylenediamine, adipic acid)
PA 210 (ethylenediamine, sebacic acid)
PA 46 (tetramethylenediamine, adipic acid)
PA 66 (hexamethylenediamine, adipic acid)
PA 69 (hexamethylenediamine, azelaic acid)
PA 610 (hexamethylenediamine, sebacic acid)
PA 612 (hexamethylenediamine, decanedicarboxylic acid)
PA 613 (hexamethylenediamine, undecanedicarboxylic acid)
PA 1212 (1,12-dodecanediamine, decanedicarboxylic acid)
PA 1313 (1,13-diaminotridecane, undecanedicarboxylic acid)
PA MXD6 (m-xylylenediamine, adipic acid)
PA TMDT (trimethylhexamethylenediamine, terephthalic acid)
PA 4 (pyrrolidone)
PA 6 (ε-caprolactam)
PA 7 (ε-amino-enanthicaciol)
PA 8 (capryllactam)
PA 9 (9-aminononanoic acid)
poly(p-phenylenediamineterephthalamide) (phenylenediamine, terephthalic acid)
PA11 (11-aminoundecanoic acid)
PA12 (laurolactam)
or a mixture or copolymer thereof.

17. A process for producing the thermoplastic molding compositions according to claim 10 which comprises mixing of the components, preferably in an extruder.

18. A process for producing the thermoplastic molding compositions according to claim 13 which comprises mixing of the components in an extruder.

19. A process for producing conductive moldings which comprises utilizing the thermoplastic molding composition according to claim 10.

20. A molding made of the thermoplastic molding composition according to claim 10.
